(19) United States
(12) Patent Application Publication
(10) Pub. No.: US 2015/0322175 A1
(43) Pub. Date: Nov. 12, 2015

(54) LEGUME SEED POLYSACCHARIDE SUCCINIC ACID DERIVATIVE ESTER, AND METHOD FOR PRODUCING SAME

(71) Applicant: FUJI OIL COMPANY LIMITED, Izumisano-shi, Osaka (JP)

(72) Inventors: Minami SATO, Tsukubamirai-shi, Ibaraki (JP); Yasuhiko YOSHIDA, Tsukubamirai-shi, Ibaraki (JP); Akihiro NAKAMURA, Tsukubamirai-shi, Ibaraki (JP)

(21) Appl. No.: 14/408,990

(22) PCT Filed: Jun. 11, 2013
(86) PCT No.: PCT/JP2013/066040

§ 371 Date: Dec. 18, 2014

(30) Foreign Application Priority Data
Jun. 21, 2012 (JP) 2012-139994
Oct. 12, 2012 (JP) 2012-226468

(51) Int. Cl. C08B 37/00; A23C 9/154; A23L 1/035

(52) U.S. Cl. CPC C08B 37/0045; A23L 1/035; A23C 9/1542; A23V 2002/00

(57) ABSTRACT

The object of the present invention is to provide a dispersion stabilizer that can minimize coagulated precipitation of a protein under acidic conditions, especially in the pH range of around pH 5 which is closer to neutrality than the range around the isoelectric point of the protein. It is possible to stabilize dispersion of protein particles around pH 5, and thus prepare an acidic protein food, by using a legume seed polysaccharide esterified with a succinic acid derivative having a hydrocarbon chain bonded to the 2-position carbon of succinic acid or succinic acid. The hydrocarbon chain of the succinic acid derivative preferably has 2 to 18 carbon atoms, and is most preferably an octenyl group. The esterified legume seed polysaccharides also have high emulsifying ability.

### TECHNICAL FIELD

The present invention relates to a pectinic acidic polysaccharide derived from a legume plant seed (hereunder referred to as “legume seed polysaccharide”), having uronic acid as a constituent sugar. Specifically, it relates to a legume seed polysaccharide having excellent dispersion stabilizing ability for particles of protein molecules and the like in aqueous solutions, compared to dispersion stabilizers used in the prior art. In particular, the invention relates to an esterified legume seed polysaccharide having a succinic acid derivative ester structure in the molecule, which is suitable for exhibiting high dispersion stabilizing ability, and to a dispersion stabilizer using the same.

### BACKGROUND ART

Foods prepared by fermenting protein beverages such as milk and soy milk using microorganisms such as lactic acid bacteria, as well as foods prepared by adding fruit juices, inorganic acids or organic acids to them, are known as acidic protein foods or beverages, and examples include acidic protein beverages, acidic frozen desserts and acidic desserts. With such acidic protein foods and beverages, and especially acidic protein beverages, a problem is encountered in that the milk proteins and soybean proteins contained therein coagulate at around pH 4.5, which is the isoelectric point, and beverages with precipitation or separation due to coagulation of proteins lose much of their commercial value.

Therefore, dispersion stabilizers are added to disperse the proteins under acidic conditions around the isoelectric point. Soybean polysaccharides exhibit a protein dispersion-stabilizing effect in the pH range of below 4.2, and can yield beverages having low viscosity and a clean drinkable feel (PTL 1). Other dispersion stabilizers that disperse proteins under acidic conditions around the isoelectric point include high-methoxylpectin (HM-pectin) and carboxymethyl cellulose (CMC), which can stabilize dispersion of proteins at pH 4.2 to 4.6.

There has also been proposed addition of potato pectin (PTL 2) or microorganically derived polyglutamic acid (PTL 3) at around pH 5 which is higher than the isoelectric point. However, separation of the starch in potato pectin is difficult, while beverages prepared with microorganically-derived polyglutamic acid have low heating stability and cannot withstand the heat sterilization step that is highly essential for food processing, and therefore both are poorly practical. At the current time, no dispersion stabilizer exists that is practical for preparing satisfactory acidic protein beverages at around pH 5.

Incidentally, techniques are known for a succinic acid derivative esterification of saccharides that include monosaccharides, oligosaccharides, polysaccharides and starches, with octenylsuccinate starch being most commonly used. This is one type of processed starch, and since octenylsuccination increases the hydrophobicity and improves surfactancy, it is used as an emulsifying agent and as a viscosity stabilizer in oily food products (NPL 1). Other succinic acid derivative esterified saccharides are used as cleaning agents or foaming stabilizers by utilizing their high surfactancy (PTL 4), but the use of a succinic acid derivative esterified saccharides for the purpose of preventing coagulated precipitation of proteins is not known.

### CITATION LIST

### Patent Literature

[PTL 1] Japanese Unexamined Patent Application Publication HEI No. 7-59512
[PTL 2] Japanese Unexamined Patent Application Publication No. 2004-41239
[PTL 3] Japanese Unexamined Patent Application Publication No. 2007-259807
[PTL 4] Japanese Unexamined Patent Application Publication HEI No. 6-72823

### Non Patent Literature

[NPL 1] Kogyo Gijutsukai, ed.: “Food emulsifiers and emulsifying techniques” (1995), pp. 264-273

### SUMMARY OF INVENTION

### Technical Problem

It is an object of the present invention to provide a dispersion stabilizer that can minimize coagulated precipitation of proteins under acidic conditions, and especially in the pH range of around pH 5 which is closer to neutrality than the isoelectric point of milk proteins or soybean proteins.

### Solution to Problem

As a result of much diligent research on this issue, the present inventors have found that legume seed polysaccharides esterified by a succinic acid having a hydrocarbon bonded to an ethylene group can stabilize dispersion of milk protein particles around pH 5, and upon conducting further research, we have determined the optimal hydrocarbon chain lengths and contents. We further found that the obtained esterified legume seed polysaccharides have not only dispersing ability for milk proteins but also high emulsifying ability, and have thereupon completed this invention.

Specifically, the present invention relates to the following.

(1) An esterified legume seed polysaccharide which is a pectinic acidic polysaccharide derived from a legume plant seed having uronic acid as a constituent sugar (hereunder referred to as “legume seed polysaccharide”), and containing an ester of succinic acid or a succinic acid derivative, represented by the following structural formula:

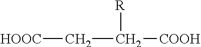

wherein R is a hydrogen atom or a hydrocarbon chain.
(2) An esterified legume seed polysaccharide according to (1), wherein R has 2 to 18 carbon atoms.
(3) An esterified legume seed polysaccharide according to (1), wherein R is an octenyl group.
(4) An esterified legume seed polysaccharide according to (1), wherein the amount of the succinic acid ester or the succinic acid derivative ester is 0.01 to 40% as free acid weight percentage with respect to the esterified legume seed polysaccharide.
(5) A method for producing an esterified legume seed polysaccharide according to (1), wherein a legume seed polysaccharide is allowed to react with a succinic anhydride or a succinic acid derivative anhydride.
(6) A dispersion stabilizer employing an esterified legume seed polysaccharide according to (1).
(7) An acidic protein food or beverage employing a dispersion stabilizer according to (6).
(8) An emulsifying agent employing an esterified legume seed polysaccharide according to (1).
(9) A food, cosmetic or chemical product employing an emulsifying agent according to (8).

### Advantageous Effects of Invention

According to the invention it is possible to obtain a legume seed polysaccharide that stabilizes dispersion and minimizes coagulated precipitation of proteins around pH 5, and to use the legume seed polysaccharide to provide acidic protein beverages or acidic protein foods, that have not been obtainable in the prior art. It is also possible to provide a novel emulsifying agent having high emulsifying ability.

### DESCRIPTION OF EMBODIMENTS

(Legume Seed Polysaccharide)

The invention will now be explained in further detail. For the purpose of the invention, a “legume seed polysaccharide” is a pectinic acidic polysaccharide derived from a legume plant seed comprising uronic acid as a constituent sugar, and it can be obtained by various methods from seeds of legume plants such as soybean, pea, adzuki bean, cowpea, common bean, broad bean, chickpea, lentil and peanut.

For soybeans, there may be used the different soybean polysaccharides mentioned in Japanese Patent No. 2599477. As an example of production using soybean, it can be obtained from tofu or soy milk, okara obtained as a by-product of production of soybean protein isolate, or defatted soybean lees (meal) as the starting material, obtaining the soybean polysaccharides by high-temperature extraction in the weakly acidic range which is around the isoelectric point of soybean protein in aqueous systems, and preferably pH 4-6, and subsequent solid-liquid separation. Okara from production of soybean protein isolate is preferred as a starting material, as it has both low oil and protein contents. The extraction temperature is preferably higher than 100° C. for high extraction efficiency, and more preferably it is no higher than 130° C.

Soybean polysaccharides obtained in this manner contain at least rhamnose, fucose, arabinose, galactose and glucose in addition to uronic acid as the major constituent sugar, and most preferably have a composition of 1 to 7 wt % rhamnose, 2 to 8 wt % fucose, 15 to 50 wt % arabinose, 2 to 10 wt % xylose and 25 to 60 wt % galactose. Uronic acid may include forms where the 6-position carboxyl group is methylesterified, and its proportion is not particularly restricted.

(Uronic Acid of Legume Seed Polysaccharide)

The uronic acid content of the extracted legume seed polysaccharide is preferably 2% to 50% and more preferably 5% to 35% based on weight. The uronic acid content is determined by colorimetry based on the Blumenkrantz method. The uronic acid is preferably galacturonic acid.

(Molecular Weight of Legume Seed Polysaccharide)

The extracted legume seed polysaccharide may be used at any desired molecular weight for esterification reaction with succinic acid or a succinic acid derivative, but the average molecular weight is preferably 5000 to 1,500,000, and more preferably 50,000 to 1,000,000 in the case of soybean. The fraction with molecular weight of 10,000 or greater is preferred. The average molecular weight is the value determined by gel filtration HPLC using a TSK-GEL G-5000WXL column, with standard pullulan (product of Showa Denko K.K.) as the standard substance.

(Esterified Legume Seed Polysaccharide)

According to the invention, an “esterified legume seed polysaccharide” is a legume seed polysaccharide having in the molecule an ester bond between the hydroxyl group of the legume seed polysaccharide and succinic acid or a succinic acid derivative. The method for preparing the esterified legume seed polysaccharide may be esterification reaction of an extraction filtrate or purified extraction filtrate of legume seed polysaccharide with succinic acid or a succinic acid derivative mentioned below, or esterification reaction of a further dried extraction filtrate or its purified form with succinic acid or a succinic acid derivative.

(Structure of Succinic Acid or a Succinic Acid Derivative)

According to the invention, succinic acid or a succinic acid derivative used for esterification of the legume seed polysaccharide is represented by the structural formula shown below. In the formula, R is a hydrogen atom or a hydrocarbon chain, and preferably a hydrocarbon chain with 2 to 18, more preferably 6 to 12 and most preferably 8 carbon atoms. When R is a hydrocarbon chain, its structure is not particularly restricted and may be saturated, unsaturated, straight-chain, branched, cyclic or the like, but it is preferably an alkyl group or an alkenyl group, and more preferably an alkenyl group.

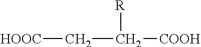

(Esterification with Succinic Acid or a Succinic Acid Derivative)

The esterification with succinic acid or a succinic acid derivative can be accomplished by any of various methods, and for example, it may be accomplished by adding a succinic anhydride or a succinic acid derivative anhydride as a reactant to an aqueous solution of a legume seed polysaccharide, or a mixed solution comprising the aqueous solution and a hydrophilic polar organic solvent such as ethanol, isopropanol or acetone, and stirring and mixing the components. Addition of the reactants may be addition of the entire amount or sequential addition after division of the reactants, selecting an appropriate addition method according to the circumstances. The concentration of the aqueous solution of the legume seed polysaccharide is not particularly limited so long as it is a concentration that allows stirring, but since a low concentration is not practical because of poor reaction efficiency and high production cost, while a high concentration results in poor manageability due to the increased viscosity, the concentration is preferably 1 to 30 wt % and more preferably 5 to 20 wt %. The reaction may be carried out with the legume seed polysaccharide as a slurry, as a mixed solution of a hydrophilic polar organic solvent and water, even when the legume seed polysaccharide is poorly soluble. The slurry concentration of the legume seed polysaccharide in this case is not particularly restricted but is preferably 1 to 60 wt %, in order to increase manageability and production efficiency.

The reaction is conducted while stirring and maintaining a solution pH of between weakly acidic and alkaline. There are no particular restrictions on the acid or alkali agent used for pH adjustment, with examples of acids including inorganic acids such as hydrochloric acid, sulfuric acid and phosphoric acid and organic acids such as acetic acid, citric acid, lactic acid and ascorbic acid, and examples of alkali agents including alkali metal hydroxides such as sodium hydroxide, potassium hydroxide and lithium hydroxide, alkali metal carbonates such as potassium carbonate, sodium carbonate and sodium hydrogencarbonate, alkali metal organic acid salts such as sodium citrate and sodium oxalate, alkali metal inorganic acid salts such as trisodium phosphate, divalent metal hydroxides such as calcium hydroxide, magnesium hydroxide and barium hydroxide, and ammonia. Since the pH of the reaction mixture will be lowered by addition of a succinic anhydride or a succinic acid derivative anhydride, the acid or alkali agent is added during the reaction to maintain the pH. The reaction pH is preferably 6 to 10, more preferably pH 7 to 10 and most preferably pH 7 to 9. The reaction temperature may be appropriately adjusted to a temperature at which the reaction mixture does not freeze and the succinic anhydride or the succinic acid derivative anhydride dissolves, but if the temperature is too low the anhydride reactivity will be low while if the temperature is too high, sudden hydrolysis of the anhydride will take place preferentially, and therefore the temperature is preferably selected between 20° C. to 90° C., in consideration of production cost and production efficiency. The reaction time will depend on the substrate and reactant concentrations, the pH and the temperature, and it may be 15 minutes to 12 hours and preferably 30 minutes to 6 hours, for example.

The esterified legume seed polysaccharide of the invention has a succinic acid or a succinic acid derivative ester bonded to a polysaccharide. The content of the succinic acid ester or the succinic acid derivative ester with respect to the legume seed polysaccharide is preferably selected as appropriate between 0.01 to 40 wt % in terms of free acid, according to the desired function. For use as a dispersion stabilizer, the succinic acid derivative ester content is preferably 2.0 to 10.0 wt %/o in terms of free acid, while for use as an emulsifying agent, the succinic acid derivative ester content is preferably 0.2 wt % or greater and more preferably 0.3 to 7.0 wt % in terms of free acid.

(Purifying Treatment)

The legume seed polysaccharide starting material, or the legume seed polysaccharide after esterification, preferably the legume seed polysaccharide after esterification, and more preferably the legume seed polysaccharide that has been neutralized after esterification, may be subjected to purifying treatment if necessary. When the starting material has not been deproteinized beforehand, the crude protein can adversely affect the function, and it is therefore preferably removed. The deproteinizing method may be a method in which the pH is adjusted to around the isoelectric point of soybean protein using an acid or alkali to induce coagulation of the protein, and the aggregates are removed by forced filtration separation, centrifugal separation, filtration, membrane separation or the like, a method in which an optional protease is used for decomposition, or a method in which active carbon or a resin is used for adsorption removal. Any one or combination of two or more of these methods are preferably used to remove contaminating protein.

A method of desalting and purification may be any method that allows separation and removal of the salts. Examples include reprecipitation

methods using polar organic solvents such as methanol, ethanol, isopropanol or acetone, activated carbon treatment, resin adsorption treatment, ultrafiltration methods, reverse osmosis methods, gel filtration methods, dialysis methods, ion exchange resin methods, electrodialysis methods and ion-exchange membrane methods, and these are preferably carried out either alone or in combinations of two or more.

A solution of an esterified legume seed polysaccharide that has been subjected to purifying treatment, or not subjected to such treatment, may be concentrated if necessary and subjected to sterilization treatment such as plate sterilization or steam sterilization, and then dried. The drying method may be freeze-drying, spray drying, drum dryer drying or the like, and pulverization may be carried out after drying if necessary. These methods can be selected as desired depending on the state of the legume seed polysaccharide before treatment.

(Quantitation of the Succinic Acid Derivative Ester)

The degree of esterification with the succinic acid derivative is determined by calculating the amount of free acid of the succinic acid derivative ester bonded to the legume seed polysaccharide, by the following formula, and expressing it as a weight percentage with respect to the esterified legume seed polysaccharide.

Succinic acid derivative amount (in terms of free acid)=1.4×V2−V1 The term V1 in the formula is the value of the amount of free succinic acid derivative in solution when a 5 ml solution containing the esterified legume seed polysaccharide sample dissolved at 1 wt % in 10 mM phosphate buffer (pH 7.2) is passed through a molecular weight 10,000 cut filter (Amicon Ultra Ultracel-10 membrane: Merck, Ltd.), quantified by reversed-phase chromatography. Also, V2 is the value of the amount of the succinic acid derivative in solution obtained by adding 1 ml of 0.5N sodium hydroxide to 5 ml of solution of the same sample dissolved in 1 wt % of 10 mM phosphate buffer (pH 7.2), conducting ester hydrolysis at 40° C. for 20 minutes, and then adding 1 ml of 0.5N hydrochloric acid for neutralization and passing it through a molecular weight 10,000 cut filter (same as above), and quantifying in the same manner.

The reversed-phase chromatography is carried out under the following conditions. Column: CAPCELL PAK C18 MG (φ2.0 mm×150 mm, product of Shiseido Corp.), eluent: 0.1 wt %/o phosphoric acid/acetonitrile mixed solution (acetonitrile concentration of 35 vol % with hexenylsuccinic acid measurement, 50 vol % with octenylsuccinic acid measurement and 60 vol % with dodecenylsuccinic acid measurement), flow rate: 0.4 ml/min, detector: UV detector (wavelength: 205 nm). The internal standard substance used is caprylic acid monoglyceride for hexenylsuccinic acid measurement, capric acid monoglyceride for octenylsuccinic acid measurement and decanoic acid for dodecenylsuccinic acid measurement.

(Dispersion Stabilizer)

The esterified legume seed polysaccharide of the invention functions as a dispersion stabilizer to inhibit coagulation of proteins in aqueous solution and maintain a dispersion-stabilized state. This function is effective in a range of pH 4.6 to 5.2 and preferably pH 4.8 to 5.0, and is suitable for acidic protein foods or beverages and especially acidic protein beverages.

The dispersion stabilizer of the invention allows preparation of satisfactory acidic protein beverages without coagulated precipitation of the protein in a pH range of 4.6 to 5.2, a range for which no practical stabilizer has existed in the prior art. Polysaccharides, proteins and other macromolecules or their hydrolysates may also be used in combination, depending on the physical properties and nature of the acidic protein food or beverage to be prepared. Examples of such other components include one or combinations of two or more from among polysaccharides including starches, processed starches, celluloses, dextrin, inulin, agar, carrageenan, fucoidan, sodium alginate, furcellaran, guar gum, locust bean gum, tamarind seed polysaccharides, tara gum, gum arabic, tragacanth gum, karaya gum, pectin, xanthan gum, pullulan, gellan gum, chitin, chitosan and the like, as well as proteins such as gelatin and collagen.

The dispersion stabilizer of the invention effectively functions in a protein food or beverage, without restrictions on the lower limit for the concentration of the protein as the disperse phase. It is possible to provide a refreshing food or beverage having sufficient stabilization when the protein concentration is 2.5% or greater, as well as low viscosity compared to other dispersion stabilizers. By addition to an acidic protein food or beverage at 0.05 to 2.0 wt %, preferably 0.1 to 1.5 wt % and more preferably 0.2 to 1.0 wt %, satisfactory protein dispersion stability is exhibited in a range slightly more neutral than the isoelectric point of the protein. This is suitable for preparation of acidic protein foods or beverages at pH 4.6 to 5.2, and an especially satisfactory coagulation-inhibiting effect is exhibited at pH 4.8 to 5.0.

(Acidic Protein Food or Beverage)

An acidic protein food or beverage according to the invention is an acidic food or beverage containing animal or vegetable protein material, and it can be obtained by adding a fruit juice such as citrus or an inorganic acid such as phosphoric acid, or another acid, to a food or beverage using animal or vegetable protein material, or by adding an organic acid such as citric acid or lactic acid, or by fermentative production using microorganisms. Specific examples include acidic milk beverages prepared from solutions of animal or vegetable protein such as dairy products that have been rendered acidic, acidic ice desserts obtained by adding fruit juice to milk protein component-containing frozen desserts such as ice cream, acidic frozen desserts such as frozen yogurt, acidic desserts obtained by adding fruit juice to gelled foods such as pudding or bavarois, coffee beverages, live-type or sterilized-type lactic acid bacteria beverages, and solid or liquid fermented milk. Fermented milk refers to fermented milk that has been fermented with addition of lactic acid bacteria or a starter after sterilization of animal or vegetable protein, and optionally it may be powdered or have added sugar.

Also, “animal or vegetable protein material” refers to protein material derived from animal milk, soy milk or the like, and specifically cow milk, goat milk, nonfat milk or soybean milk, or their powdered products such as whole milk powder, skim milk powder or soybean milk powder, as well as sweetened milk that contains sugar, concentrated milk, and processed milk and fermented milk that have been fortified with minerals such as calcium or vitamins.

(Emulsifying Agent)

The esterified legume seed polysaccharide of the invention emulsifies more hydrophobic substances, allowing formation of oil-in-water (O/W) emulsions, at lower contents compared to gum arabic, processed starch or conventional soybean polysaccharides, that are most widely used as macromolecular emulsifying agents. It can also be used as an emulsifying agent for drugs, quasi drugs, cosmetics and the like, in addition to the field of foods, in order to provide emulsions having excellent dispersion stabilizing ability that prevent destruction of the emulsions or formation of masses of the emulsions, and having high resistance to changes in pH, temperature and salt concentration, as well as resistance to dilution and protease treatment.

Foods in which the esterified legume seed polysaccharide of the invention may be used include beverages such as soft drinks, milk beverages, fruit drinks, teas, sports drinks, diet beverages, powdered beverages and alcoholic beverages, confectioneries such as candy, oleaster, jelly and chewing gum, frozen desserts such as ice cream, foods and beverages such as dressings, mayonnaise, bakery products, processed seafood products, livestock products, retort foods and frozen foods, and it may be used as an emulsifying agent for emulsification of oil-based aromatics and oil-based pigments as well.

Uses other than in the field of foods include its use as an emulsification for cosmetics such as face cleansers, moisturizing creams, cosmetic waters and foundations, hair care products such as shampoos, coloring agents and styling agents, drugs and pharmaceutical coating agents such as application drugs and anticancer agents, daily commodities such as bath additives, clothing detergents and household cleansers, agricultural chemicals such as insecticides and herbicides, and finishing agents such as paints, inks and waxes.

The esterified legume seed polysaccharide of the invention can be used as a liquid or powdered emulsifying agent, but other carriers or additives may also be added to prepare an emulsified formulation. In such cases, the carriers or additives used may be appropriately selected according to the type and purpose of the product in which the emulsifying agent is to be used. For example, the esterified legume seed polysaccharide may be used in admixture with polyhydric alcohols such as glycerin, saccharides such as dextrin and lactose, antioxidants such as ascorbic acid and additives such as antiseptic agents.

The emulsifying agent of the invention is preferably used at 4 to 200 wt % and more preferably at 10 to 100 wt % with respect to the oil phase. For use, preferably the emulsifying agent is dissolved or dispersed in an aqueous phase and then mixed with an oil phase and emulsified. The pH of the emulsion is preferably pH 2 to 9 and more preferably pH 3 to 7.

The esterified legume seed polysaccharide of the invention may also be used in combination with other emulsifying agents if necessary. Examples of other emulsifying agents to be used in combination include low molecular emulsifying agents, for example, anionic surfactants such as fatty acid soaps, cationic surfactants such as quaternary ammonium compounds, nonionic surfactants such as glycerin fatty acid esters and sugar esters, and amphoteric surfactants such as lecithin, and high molecular emulsifying agents such as gum arabic, casein sodium, propyleneglycol alginate ester, processed starches and carboxymethyl cellulose. Agar, carrageenan, pectin, karaya gum, guar gum, locust bean gum, xanthan gum, gellan gum, sodium alginate, gelatin, starches and the like may also be used in combination as emulsification stabilizers.

The present invention will now be further explained by examples, with the understanding that the technical concept of the invention is not limited to the examples.

### Production Example 1

### Preparation of Untreated or Alkali Treated Soybean Polysaccharide

Using dried okara produced as a by-product from isolated soybean protein production as the starting material, water was added to a solid content of 8.0 wt %, and after adjustment to pH 5.0, hot extraction was performed at 120° C. for 90 minutes. It was then centrifuged (11,000×g, 30 min) and a supernatant was obtained. A portion of the obtained supernatant was freeze-dried to obtain soybean polysaccharide Y (untreated soybean polysaccharide). The remaining 300 g of supernatant was adjusted to pH 8.0 using sodium hydroxide, and after continuing stirring for 1 hour while maintaining a state of pH 8.0, 40° C., hydrochloric acid was added to the solution for adjustment to pH 5, and 600 g of ethanol was added to precipitate the polysaccharide. The isolated precipitate was washed twice with 300 g of ethanol and then air-dried, to obtain soybean polysaccharide Z (alkali treated soybean polysaccharide).

### Production Example 2

### Preparation of Octenylsuccinated Soybean Polysaccharide (1)

A 300 g portion of a 10 wt % solution of soybean polysaccharide Y was prepared and heated to 40° C. A sodium hydroxide solution was used for adjustment to pH 8.0, and after adding octenylsuccinic anhydride (2-octenylsuccinic anhydride, product of Tokyo Kasei Kogyo Co., Ltd.) at a concentration of 30 wt % with respect to the soybean polysaccharide, in a ⅓ amount every 30 minutes, while stirring and mixing with the temperature at 40° C., stirring was continued for 1 hour for esterification reaction. During the reaction, the pH was kept at 8.0 by addition of sodium hydroxide. Hydrochloric acid was added to the solution for adjustment to pH 5, and then 600 g of ethanol was added to precipitate the polysaccharide. The isolated precipitate was washed twice with 300 g of ethanol and then air-dried, to obtain esterified soybean polysaccharide A.

### Production Example 3

### Preparation of Octenylsuccinated Soybean Polysaccharides (2)

Esterified soybean polysaccharides B, C, D and E were obtained by the same procedure as for esterified soybean polysaccharide A, except that the amount of octenylsuccinic anhydride added during production of soybean polysaccharide A in Production Example 2 was changed to 10, 6.0, 3.0 and 1.5 wt % with respect to the soybean polysaccharide.

### Production Example 4

### Preparation of Hexenylsuccinated Soybean Polysaccharides

Esterified soybean polysaccharides F, G and H were obtained by the same procedure, except that the octenylsuccinic anhydride used for production of esterified soybean polysaccharide A, B and D in Production Examples 2 and 3 was changed to hexenylsuccinic anhydride (2-hexen-1-yl-succinic anhydride: product of Tokyo Kasei Kogyo Co., Ltd.).

### Production Example 5

### Preparation of Dodecenylsuccinated Soybean Polysaccharide (1)

Esterified soybean polysaccharide I was obtained by the same procedure, except that in the production of esterified soybean polysaccharide A in Production Example 2, the reaction temperature was changed to 80° C., octenylsuccinic anhydride was changed to dodecenylsuccinic anhydride (2-decen-1-yl-succinic anhydride: product of Tokyo Kasei Kogyo Co., Ltd.), the amount of addition was changed to 40 wt % with respect to the soybean polysaccharide, and the reaction time was changed to 6 hours.

### Production Example 6

### Preparation of Dodecenylsuccinated Soybean Polysaccharides (2)

Esterified soybean polysaccharides J, K and L were obtained by the same procedure, except that for the production of esterified soybean polysaccharides A, B and D in Production Examples 2 and 3, the reaction temperature was changed to 80° C. and the octenylsuccinic anhydride was changed to dodecenylsuccinic anhydride.

### Production Example 7

### Preparation of n-Octylsuccinated Soybean Polysaccharides

Esterified soybean polysaccharides M, N and O were obtained by the same procedure, except that for the production of esterified soybean polysaccharides A, B and D in Production Examples 2 and 3, the reaction temperature was changed to 70° C. and the octenylsuccinic anhydride was changed to n-octylsuccinic anhydride (product of Tokyo Kasei Kogyo Co., Ltd.).

### Production Example 8

### Preparation of Untreated or Alkali Treated Pea Polysaccharide

A 4-fold amount by weight of water was added to pea cotyledon that had been immersed in water overnight, and sodium hydroxide was added for adjustment to pH 8.5. A homomixer was used for stirred pulverization at 7000 rpm for 30 minutes, and the solution was squeezed with a filter cloth to separate out the fiber. A 4-fold amount of water by weight was added to the fiber, and stirring and separation were carried out in the same manner two more times to obtain thrice-extracted pea fiber. Water was added to the thrice-extracted pea fiber to a solid content of 8.0 wt %, and after adjustment to pH 5.0, it was subjected to hot extraction at 120° C. for 90 minutes. It was then centrifuged (11,000×g, 30 min) and a supernatant was obtained. A portion of the obtained supernatant was freeze-dried to obtain pea polysaccharide Y (untreated pea polysaccharide). The remaining 300 g of supernatant was adjusted to pH 8.0 using sodium hydroxide, and after continuing to stir for 1 hour while maintaining a state of pH 8.0, 40° C., hydrochloric acid was added to the solution for adjustment to pH 5, and 600 g of ethanol was added to precipitate the polysaccharide. The isolated precipitate was washed twice with 300 g of ethanol and then air-dried, to obtain pea polysaccharide Z (alkali treated pea polysaccharide).

### Production Example 9

### Preparation of Octenylsuccinated Pea Polysaccharides

Esterified pea polysaccharide C was obtained by the same procedure, except that in the production of esterified soybean polysaccharide C in Production Example 3, the soybean polysaccharide Y was changed to pea polysaccharide Y.

### Production Example 10

### Preparation of Untreated and Alkali Treated Common Bean Polysaccharides

Common bean polysaccharides Y and Z were obtained by the same procedure, except that in production of the pea polysaccharides Y and Z of Production Example 8, pea was changed to common bean.

### Production Example 11

### Preparation of Octenylsuccinated Common Bean Polysaccharides

Esterified common bean polysaccharides A and B were obtained by the same procedure, except that in the production of esterified soybean polysaccharides A and B in Production Examples 2 and 3, the soybean polysaccharide Y was changed to common bean polysaccharide Y.

### Production Example 12

### Preparation of Untreated and Alkali Treated Mung Bean Polysaccharides

Mung bean polysaccharides Y and Z were obtained by the same procedure, except that in production of the pea polysaccharides Y and Z of Production Example 8, the pea was changed to mung bean.

### Production Example 13

### Preparation of Octenylsuccinated Mung Bean Polysaccharides

Esterified mung bean polysaccharides A and B were obtained by the same procedure, except that in the production of esterified soybean polysaccharides A and B in Production Examples 2 and 3, the soybean polysaccharide was changed to mung bean polysaccharide.

### Comparative Production Example 1

### Preparation of Octenylsuccinated Gum Arabic (1)

Gum arabic A was obtained by the same procedure, except that in production of the soybean polysaccharide D in Production Example 3, the soybean polysaccharide was changed to gum arabic of Acacia senegal seeds (Arabic Cole SS: product of San-Ei Yakuhin Boeki Co., Ltd.). However, no octenylsuccination was found.

### Comparative Production Example 2

### Preparation of Octenylsuccinated Gum Arabic (2)

Gum arabic B was obtained by the same procedure, except that in production of the soybean polysaccharide D in Production Example 3, the soybean polysaccharide was changed to gum arabic of Acacia seyal seeds (Gum Acacia 386A: product of Alland & Robert). However, no octenylsuccination was found.

The analysis values for reversed-phase chromatography of the polysaccharides obtained in Production Examples 1 to 13 and Comparative Production Examples 1 and 2, and gum arabic (Arabic Cole SS, Gum Acacia 386A), and octenylsuccinated gum arabic (Ticamulsion: product of TIC Gums) are shown in Table 1. Succinic acid derivative esters were introduced into each of the esterified legume seed polysaccharides. For gum arabics A and B, no succinic acid derivative ester was introduced.

TABLE 1
Measured values for polysaccharides

| | | | | | Uronic |
|---|---|---|---|---|---|
| | | | Amount of succinic acid derivative | | acid |
| | | R | (wt %) | | content |
| | | carbon number | Addition amount (*1) | Binding amount (*2) | (wt %) |
| Soybean polysaccharide | Z | — | — | 0.0 | 32.4 |
| Esterified soybean polysaccharide | A | 8 | 30 | 9.2 | |
| | B | 8 | 10 | 4.5 | |
| | C | 8 | 6 | 2.7 | |
| | D | 8 | 3 | 0.9 | |
| | E | 8 | 1.5 | 0.2 | |
| | F | 6 | 30 | 18.5 | |
| | G | 6 | 10 | 6.6 | |
| | H | 6 | 3 | 1.0 | |
| | I | 12 | 40 | 3.2 | |
| | J | 12 | 30 | 1.1 | |
| | K | 12 | 10 | 0.5 | |
| | L | 12 | 3 | 0.1 | |
| | M | 8 (saturated) | 30 | 2.6 | |
| | N | 8 (saturated) | 10 | 1.4 | |
| | O | 8 (saturated) | 3 | 0.3 | |
| Pea polysaccharide | Z | — | — | 0.0 | 9.9 |
| Esterified pea polysaccharide | C | 8 | 6 | 4.9 | |
| Common bean polysaccharide | Z | — | — | 0.0 | 20.2 |
| Esterified common bean | A | 8 | 30 | 6.1 | |
| polysaccharide | B | 8 | 10 | 3.3 | |
| Mung bean polysaccharide | Z | — | — | 0.0 | 6.9 |
| Esterified mung bean | A | 8 | 30 | 4.9 | |
| polysaccharide | B | 8 | 10 | 2.2 | |

| | | | | |
|---|---|---|---|---|
| Arabic Cole SS | — | — | 0.0 | |
| Gum Acacia 386A | | — | — | 0.0 |
| Gum arabic A | | 8 | 3 | 0.0 |
| Gum arabic B | | 8 | 3 | 0.0 |
| Ticamulsion | | 8 | — | 0.9 |

(*1) Amount of anhydride added to each legume seed polysaccharide
(*2) Content with respect to each esterified legume seed polysaccharide (in terms of free acid)

### Example 1

### Evaluation of Dispersion Stabilizing Ability for Acidic Milk Beverages by Esterified Legume Seed Polysaccharides 1

Preparation of acidic milk beverages (protein concentration: 1.0 wt %, stabilizer concentration: 0.2 wt %)

One selected from among esterified soybean polysaccharides A, B, G, I and M, esterified pea polysaccharide C, esterified common bean polysaccharide A and esterified mung bean polysaccharide A was mixed with skim milk powder, granulated sugar and water while on ice, in the proportions shown in Table 2, and after adjusting the pH as desired using a 50% lactic acid solution, the mixture was homogenized by high-pressure homogenization (150 kgf/cm²). The prepared beverages were stored overnight at 4° C.

TABLE 2
Acidic milk beverage compositions (protein concentration: 1%)

| Composition | (Parts by weight) |
|---|---|
| Legume seed polysaccharide | 0.2 |
| 12% Skim milk powder solution | 25.0 |
| 50% Granulated sugar solution | 14.0 |
| Water | 60.8 |

Evaluation of Acidic Milk Beverages

The prepared acidic milk beverages were evaluated for stability based on the precipitation rate and the presence or absence of coagulation.

### [Precipitation Rate]

Each acidic milk beverage was centrifuged at 750×g for 20 minutes, and the supernatant was removed by decantation. The precipitation weight was measured and the precipitation rate was determined by the following formula.

Precipitation rate (%)=Precipitation weight/weight of prepared acidic milk beverage×100

### [Coagulation]

The presence or absence of coagulation of the protein in the solution was visually confirmed and evaluated as (−): Very slight or no coagulation, or (+): coagulation. A state where no coagulation was observed but the protein dissolved and the emulsified property of the solution disappeared was recorded as “dissolved” and judged to be unsatisfactory.

Cases where the precipitation rate was 1% or lower and coagulation was judged as (−) were evaluated as G: Good, while other cases were judged as P: Poor.

### Comparative Example 1

### Comparison Between Non-Esterified Legume Seed Polysaccharide, Pectin and Esterified Gum Arabic

An acidic milk beverage was prepared and evaluated in exactly the same manner, except that the esterified legume seed polysaccharide of Example 1 was replaced with non-esterified soybean polysaccharide Z, non-esterified pea polysaccharide Z, non-esterified common bean polysaccharide Z, non-esterified mung bean polysaccharide Z, HM-pectin (SM-666: product of San-Ei Gen F.F.I., Inc.) or octenylsuccinated gum arabic (Ticamulsion: product of TIC Gums).

TABLE 3
Stability of acidic milk beverages (protein concentration: 1%)

| | | Acidic milk beverage | Beverage pH | | | | | |
|---|---|---|---|---|---|---|---|---|
| Stabilizer | | evaluation | 4.4 | 4.6 | 4.8 | 5.0 | 5.2 | 5.4 |
| Esterified soybean | A | Precipitation rate (%) | 15.7 | 0.2 | 0.1 | 0.1 | 0.1 | 0.1 |
| polysaccharide | | Coagulation | + | − | − | − | − | (dissolved) |
| | | Evaluation | P | G | G | G | G | P |
| | B | Precipitation rate (%) | 0.2 | 0.5 | 0.2 | 0.1 | 0.3 | 0.1 |
| | | Coagulation | − | − | − | − | − | (dissolved) |
| | | Evaluation | G | G | G | G | G | P |
| | G | Precipitation rate (%) | 12.7 | 0.9 | 0.5 | 0.5 | 0.6 | 0.2 |
| | | Coagulation | + | − | − | − | − | (dissolved) |
| | | Evaluation | P | G | G | G | G | P |
| | I | Precipitation rate (%) | 12.2 | 0.9 | 0.4 | 0.3 | 0.6 | 0.1 |
| | | Coagulation | + | − | − | − | − | (dissolved) |
| | | Evaluation | P | G | G | G | G | P |
| | M | Precipitation rate (%) | 0.9 | 0.5 | 0.3 | 0.3 | 0.3 | 0.1 |
| | | Coagulation | − | − | − | − | − | (dissolved) |
| | | Evaluation | G | G | G | G | G | P |
| Soybean | Z | Precipitation rate (%) | 0.8 | 5.9 | 8.9 | 9.1 | 0.7 | 0.2 |
| polysaccharide | | Coagulation | − | + | + | + | (dissolved) | (dissolved) |
| (non-esterified) | | Evaluation | G | P | P | P | P | P |
| Esterified pea | C | Precipitation rate (%) | 9.8 | 0.7 | 0.2 | 0.3 | 0.5 | 0.1 |
| polysaccharide | | Coagulation | + | − | − | − | − | (dissolved) |
| | | Evaluation | P | G | G | G | G | P |
| Pea polysaccharide | Z | Precipitation rate (%) | 0.9 | 11.9 | 13.0 | 12.5 | 0.2 | 0.1 |
| (non-esterified) | | Coagulation | − | + | + | + | (dissolved) | (dissolved) |
| | | Evaluation | G | P | P | P | P | P |
| Esterified common | A | Precipitation rate (%) | 11.1 | 0.6 | 0.4 | 0.4 | 0.5 | 0.1 |
| bean | | Coagulation | + | − | − | − | − | (dissolved) |
| polysaccharide | | Evaluation | P | G | G | G | G | P |
| Common bean | Z | Precipitation rate (%) | 0.8 | 12.7 | 11.6 | 12.6 | 0.3 | 0.1 |
| polysaccharide | | Coagulation | − | + | + | + | (dissolved) | (dissolved) |
| (non-esterified) | | Evaluation | G | P | P | P | P | P |
| Esterified mung | A | Precipitation rate (%) | 13.1 | 0.8 | 0.7 | 0.4 | 0.9 | 0.2 |
| bean | | Coagulation | + | − | − | − | − | (dissolved) |
| polysaccharide | | Evaluation | P | G | G | G | G | P |
| Mung bean | Z | Precipitation rate (%) | 11.9 | 12.4 | 12.6 | 12.2 | 0.3 | 0.2 |
| polysaccharide | | Coagulation | + | + | + | + | (dissolved) | (dissolved) |
| (non-esterified) | | Evaluation | P | P | P | P | P | P |
| SM-666 | | Precipitation rate (%) | 0.9 | 0.8 | 1.4 | 12.9 | 11.7 | 11.5 |
| | | Coagulation | − | − | + | + | + | + |
| | | Evaluation | G | G | P | P | P | P |
| Ticamulsion | | Precipitation rate (%) | 12.2 | 14.0 | 11.1 | 11.3 | 12.6 | 10.3 |
| | | Coagulation | + | + | + | + | + | + |
| | | Evaluation | P | P | P | P | P | P |

When using esterified soybean polysaccharides A, B, G, I and M, esterified pea polysaccharide C, esterified common bean polysaccharide A and esterified mung bean polysaccharide A, the protein was dispersion-stabilized in a range of pH 4.6 to 5.2, allowing preparation of a satisfactory beverage without coagulation. With the non-esterified products, i.e. soybean polysaccharide Z, pea polysaccharide Z, common bean polysaccharide Z and mung bean polysaccharide Z, the protein completely coagulated and precipitated, while with HM-pectin, stabilization at pH 4.6 and weak stabilization at pH 4.8 were observed, but stabilization could not be achieved at higher pH values. Gum arabic does not have protein dispersion stabilizing ability, while the same is true of octenylsuccinated gum arabic, and stabilization could not be achieved at any pH.

### Example 2

### Evaluation of Dispersion Stabilizing Ability for Acidic Milk Beverages by Esterified Legume Seed Polysaccharides 2

Preparation of acidic milk beverages (protein concentration: 2.5 wt %, stabilizer concentration: 0.4 wt %)

One selected from among esterified soybean polysaccharide A, esterified pea polysaccharide C, esterified common bean polysaccharide A and esterified mung bean polysaccharide A was mixed with skim milk powder, granulated sugar and water while on ice, in the proportions shown in Table 4, and after adjusting the pH as desired using a 50% lactic acid solution, it was homogenized by high-pressure homogenization (150 kgf/cm²). The prepared beverages were stored overnight at 4° C.

TABLE 4
Acidic milk beverage compositions (protein concentration: 2.5%)

| Composition | (Parts by weight) |
|---|---|
| Legume seed polysaccharide | 0.4 |
| 21% Skim milk powder solution | 40.0 |
| 50% Granulated sugar solution | 14.0 |
| Water | 45.6 |

Evaluation of Acidic Milk Beverages

The prepared acidic milk beverages were evaluated for stability based on the precipitation rate and the presence or absence of coagulation. The viscosity was also measured as an index of drinkable feel.

### [Viscosity]

The viscosity of the prepared acidic milk beverage at 10° C. was measured with a BM viscometer (No. 1 rotor, 60 rpm).

### [Precipitation Rate]

Each acidic milk beverage was centrifuged at 750×g for 20 minutes, and the supematant was removed by decantation. The precipitation weight was measured and the precipitation rate was determined by the following formula.

Precipitation rate (%)=Precipitation weight/weight of prepared acidic milk beverage×100

### [Coagulation]

The presence or absence of coagulation of the protein in the solution was visually confirmed and evaluated as (−): Very slight or no coagulation, or (+): coagulation. A state where no coagulation was observed but the protein dissolved and the emulsified property of the solution disappeared was recorded as “dissolved” and judged to be unsatisfactory.

Cases where the precipitation rate was 6% or lower and coagulation was judged as (−) were evaluated as G: Good, while other cases were judged as P: Poor.

### Comparative Example 2

### Comparison Between Pectin and Esterified Gum Arabic

An acidic milk beverage was prepared and evaluated in exactly the same manner, except that the esterified legume seed polysaccharide of Example 2 was replaced with HM-pectin (SM-666: product of San-Ei Gen F.F.I., Inc.) or octenylsuccinated gum arabic (Ticamulsion: product of TIC Gums).

TABLE 5
Stability of acidic milk beverages (protein concentration: 2.5%)

| | | Acidic milk beverage | Beverage pH | | | | | |
|---|---|---|---|---|---|---|---|---|
| Stabilizer | | evaluation | 4.4 | 4.6 | 4.8 | 5.0 | 5.2 | 5.4 |
| Esterified soybean | A | iSix(cp) | − | 15 | 13 | 13 | 12 | − |
| polysaccharide | | Precipitation rate (%) | 29.1 | 5.2 | 2.8 | 2.6 | 4.7 | 2.0 |
| | | Coagulation | + | − | − | − | − | (dissolved) |
| | | Evaluation | P | G | G | G | G | P |
| Esterified pea | C | iSix(cp) | − | 15 | 13 | 13 | 12 | − |
| polysaccharide | | Precipitation rate (%) | 28.8 | 5.2 | 2.9 | 3.1 | 4.6 | 1.9 |
| | | Coagulation | + | − | − | − | − | (dissolved) |
| | | Evaluation | P | G | G | G | G | P |
| Esterified common | A | iSix(cp) | − | 23 | 19 | 22 | 20 | − |
| bean | | Precipitation rate (%) | 29.1 | 5.5 | 3.1 | 3.5 | 4.6 | 1.7 |
| polysaccharide | | Coagulation | + | − | − | − | − | (dissolved) |
| | | Evaluation | P | G | G | G | G | P |
| Esterified mung | A | iSix(cp) | − | 12 | 13 | 11 | 14 | − |
| bean | | Precipitation rate (%) | 31.6 | 4.9 | 3.9 | 3.0 | 5.1 | 2.2 |
| polysaccharide | | Coagulation | + | − | − | − | − | (dissolved) |
| | | Evaluation | P | G | G | G | G | P |
| SM-666 | | iSix(cp) | 67 | 71 | − | − | − | − |
| | | Precipitation rate (%) | 2.9 | 5.8 | 29.6 | 31.8 | 28.0 | 26.1 |
| | | Coagulation | − | − | + | + | + | + |
| | | Evaluation | G | G | P | P | P | P |
| Ticamulsion | | iSix(cp) | − | − | − | − | − | − |
| | | Precipitation rate (%) | 26.9 | 30.3 | 30.2 | 28.8 | 31.1 | 28.0 |
| | | Coagulation | + | + | + | + | + | + |
| | | Evaluation | P | P | P | P | P | P |

When using esterified soybean polysaccharide A, esterified pea polysaccharide C, esterified common bean polysaccharide A and esterified mung bean polysaccharide A, the protein was dispersion-stabilized in a range of pH 4.6 to 5.2, and the beverage viscosity was as low as 11-23 cp. The beverage using HM-pectin was stabilized at pH 4.4 to 4.6, had a heavier drinkable feel with a viscosity of 3 to 6 times compared to using esterified legume seed polysaccharide. The octenylsuccinated gum arabic was not stabilized at any pH.

### Example 3

### Evaluation of Emulsifying Ability with Esterified Legume Seed Polysaccharide

### Preparation of Emulsified Compositions

an Aqueous Phase Comprising One Selected from Among Esterified soybean polysaccharides B-E, G, J and O, esterified pea polysaccharide C, esterified common bean polysaccharide B and esterified mung bean polysaccharide B, buffer at pH 4 (100 mM sodium citrate buffer, pH 4.0) and glycerin was pre-mixed with an oil phase comprising a mixture of lemon oil, medium chain fatty acid triglyceride and sucrose acetic acid/isobutyric acid/fatty acid ester at 2:3:5 (weight ratio), in the amounts shown in Table 6. The oil phase was added to the aqueous phase and subjected twice to ultrasonic treatment for 30 seconds on ice for emulsification. The obtained emulsion was stored overnight at 4° C.

TABLE 6
Composition of emulsified composition (parts by weight)

| | | (Oil phase/polysaccharide ratio) | | |
|---|---|---|---|---|
| | | | | Condition 3 |
| | | | | (8-fold) |
| | | Condition 1 | Condition 2 | (parts by |
| | Composition | (2-fold) | (4-fold) | wt.) |
| (Aqueous | Legume seed | 4 | 4 | 4 |
| phase) | polysaccharide | | | |
| | Glycerin | 4 | 4 | 4 |
| | pH 4 buffer | 84 | 76 | 60 |
| (Oil phase) | | 8 | 16 | 32 |

Evaluation of Emulsified Compositions

The median particle diameter of the emulsion obtained in Example 3 was measured using a laser diffraction-type particle size distribution analyzer (SALD-2000A: product of Shimadzu Corp.). The median particle diameter of the emulsion after storage for 7 days at 4° C. after preparation was also measured, and the stability was judged to be satisfactory if there was no major change in emulsified particle size.

### Comparative Example 3

### Comparison Between Non-Esterified Legume Seed Polysaccharide and Gum Arabic

An emulsified composition was prepared and evaluated in exactly the same manner, except that the esterified legume seed polysaccharide of Example 3 was replaced with non-esterified soybean polysaccharide Z, non-esterified pea polysaccharide Z, non-esterified common bean polysaccharide Z, non-esterified mung bean polysaccharide Z, commercially available gum arabic (Arabic Cole SS: product of San-Ei Yakuhin Boeki Co., Ltd.), octenylsuccinated gum arabic (Ticamulsion: product of TIC Gums) or processed starch (EMULSTER 500A: product of Matsutani Chemical Industry Co., Ltd.).

TABLE 7
Median particle diameter of emulsified compositions

| | | Days stored | Emulsion particle size (μm) | | |
|---|---|---|---|---|---|
| | | after | Condition 1 | Condition 2 | Condition 3 |
| | | preparation | (2-fold) | (4-fold) | (8-fold) |
| Esterified soybean | B | 1 | 0.62 | 0.71 | 0.67 |
| polysaccharide | | 7 | 0.62 | 0.70 | 0.65 |
| | C | 1 | 0.63 | 0.48 | 0.64 |
| | | 7 | 0.63 | 0.48 | 0.54 |
| | D | 1 | 0.51 | 0.56 | 0.53 |
| | | 7 | 0.52 | 0.57 | 0.56 |
| | E | 1 | 0.66 | 0.67 | 0.81 |
| | | 7 | 0.70 | 0.70 | 0.99 |
| | G | 1 | 0.64 | 0.54 | 0.58 |
| | | 7 | 0.55 | 0.53 | 0.57 |
| | J | 1 | 0.59 | 0.73 | 0.62 |
| | | 7 | 0.60 | 0.73 | 0.59 |
| | O | 1 | 0.54 | 0.62 | 0.47 |
| | | 7 | 0.52 | 0.60 | 0.48 |
| Soybean polysaccharide | Z | 1 | 8.21 | Emulsion disintegrated | Emulsion disintegrated |
| (non-esterified) | | 7 | 8.32 | — | — |
| Esterified pea | C | 1 | 0.63 | 0.56 | 0.57 |
| polysaccharide | | 7 | 0.63 | 0.57 | 0.58 |
| Pea polysaccharide | Z | 1 | 2.42 | 4.28 | Emulsion disintegated |
| (non-esterified) | | 7 | 2.38 | 4.28 | — |
| Esterified common bean | B | 1 | 0.92 | 0.78 | 0.68 |
| polysaccharide | | 7 | 0.90 | 0.80 | 0.69 |
| Common bean | Z | 1 | 2.85 | 3.99 | Emulsion disintegrated |
| polysaccharide | | 7 | 2.87 | 4.00 | — |
| (non-esterified) | | | | | |
| Esterified mung bean | B | 1 | 0.81 | 0.73 | 0.88 |
| polysaccharide | | 7 | 0.82 | 0.73 | 0.90 |
| Mung bean polysaccharide | Z | 1 | 7.11 | Emulsion disintegrated | Emulsion disintegrated |
| (non-esterified) | | 7 | 7.32 | — | — |

| | | | | |
|---|---|---|---|---|
| Arabic Cole SS | 1 | 1.23 | 2.63 | 4.01 |
| | 7 | 1.25 | 2.76 | Emulsion disintegrated |
| Ticamulsion | 1 | 0.74 | 1.51 | 2.09 |
| | 7 | 0.76 | 1.50 | 2.13 |
| EMULSTER 500A | 1 | 0.64 | 2.01 | 3.12 |
| | 7 | 0.81 | 2.56 | 3.39 |

Esterified soybean polysaccharides B-E, G, J and O, esterified pea polysaccharide C, esterified common bean polysaccharide B and esterified mung bean polysaccharide B had high emulsifying activity allowing emulsification of hydrophobic substances to 2 to 8 times their own weight, and formation of oil-in-water emulsions with median particle diameters of no greater than 1.0 μm. The emulsification dispersion stability was high, with virtually no change in particle diameter even after storage for 7 days. All of the esterified legume seed polysaccharides had notably improved emulsification activity compared to the non-esterified legume seed polysaccharides, and the emulsifying ability, especially in oil-rich systems, was highly superior even compared to gum arabic and processed starch. Gum arabic, as a sap-derived polysaccharide, did not exhibit the significant improvement in emulsifying ability seen with esterified legume seed polysaccharide, even after octenylsuccination. In addition, a uniform particle size distribution of the emulsified composition was obtained with the esterified legume seed polysaccharides of the invention, whereas a uniform particle size distribution was not obtained with the macromolecular emulsifying agents of the comparative examples. The particle size distribution and emulsified particle size were unchanged even after storage for 30 days at 4° C., and therefore the storage stability was satisfactory.

### INDUSTRIAL APPLICABILITY

According to the invention it is possible to provide a legume seed polysaccharide that stabilizes dispersion and minimizes coagulated precipitation of protein particles around pH 5, and to use the legume seed polysaccharide to prepare acidic protein beverages or acidic protein foods at pH 4.6 to 5.2, that have not been obtainable in the prior art.

1. An esterified legume seed polysaccharide which is a pectinic acidic polysaccharide derived from a legume plant seed having uronic acid as a constituent sugar, and containing an ester of succinic acid or a succinic acid derivative, represented by the following structural formula: 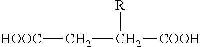
wherein R is a hydrogen atom or a hydrocarbon chain.

2. An esterified legume seed polysaccharide according to claim 1, wherein R has 2 to 18 carbon atoms.

3. An esterified legume seed polysaccharide according to claim 1, wherein R is an octenyl group.

4. An esterified legume seed polysaccharide according to claim 1, wherein the amount of the succinic acid ester or the succinic acid derivative ester is 0.01 to 40% as free acid weight percentage with respect to the esterified legume seed polysaccharide.

5. A method for producing an esterified legume seed polysaccharide according to claim 1, wherein a legume seed polysaccharide is allowed to react with a succinic anhydride or a succinic acid derivative anhydride.

6. A dispersion stabilizer employing an esterified legume seed polysaccharide according to claim 1.

7. An acidic protein food or beverage employing a dispersion stabilizer according to claim 6.

8. An emulsifying agent employing an esterified legume seed polysaccharide according to claim 1.

9. A food, cosmetic or chemical product employing an emulsifying agent according to claim 8.
